(19) United States
(12) Patent Application Publication
(10) Pub. No.: US 2018/0076692 A1
(43) Pub. Date: Mar. 15, 2018

(54) COOLING FAN AND ELECTRONIC DEVICE USING THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: LI-KAN YEH, New Taipei (TW)

(21) Appl. No.: 15/338,556

(22) Filed: Oct. 31, 2016

(30) Foreign Application Priority Data
Sep. 14, 2016 (CN) 201610825524.3

(51) Int. Cl. H02K 9/06; H02K 1/12; H02K 1/22; H02K 7/08; H02K 11/215; H02K 11/33

(52) U.S. Cl. CPC H02K 9/06; H02K 1/12; H02K 11/33; H02K 7/08; H02K 11/215; H02K 1/22

(57) ABSTRACT

A cooling fan includes a base, a stator and an rotator, one end of the stator is fixed to the base, the other end of the stator forms a shaft, the rotator is mounted to the shaft, an end of the shaft protrudes out of the rotator, each of the rotator and the shaft is <same as claims> an electromagnet driving unit matching each other, the rotator is driven to rotate by the electromagnet driving unit. An electronic device using such a cooling fan is further disclosed.

### FIELD

The subject matter herein generally relates to a cooling fan and electronic device using the cooling fan.

### BACKGROUND

Heat generated within an electronic device has a considerable influence on electronic parts inside the device.

In general, a method for exhausting the heat generated to the outside of electronic device with a cooling fan is used.

With electronic devices becoming thinner, the space for cooling fans also needs to be reduced in size.

### BRIEF DESCRIPTION OF THE DRAWINGS

Implementations of the present technology will now be described, by way of example only, with reference to the attached FIGURES.

FIG. 1 is a sectional view of one exemplary embodiment of an electronic device with a cooling fan.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “comprising,” when utilized, means “including, but not necessarily limited to”; it specifically indicates open-ended inclusion or membership in the so-described combination, group, series, and the like.

The present disclosure is described in relation to a cooling fan for cooling an electronic device.

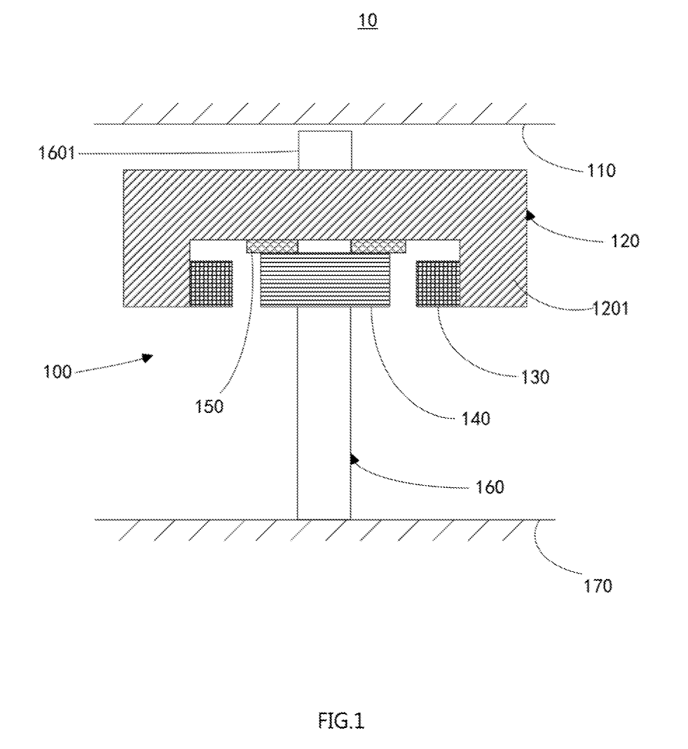

FIG. 1 illustrates one exemplary embodiment of a cooling fan 100 of an electronic device 10. The cooling fan 100 includes a base 170, a stator 160 and a rotator 120.

The stator 160 includes two opposite ends, one end of the stator 160 is fixed to the base 170, the other end of the stator 160 forms a shaft 1601, the rotator 120 is rotatably mounted to the shaft 1601, an end of the shaft 1601 protrudes out of the rotator 120, each of the rotator 120 and the shaft 1601 is equipped with an electromagnet driving unit matching each other, the rotator 120 is driven to rotate about the shaft 1601 by the electromagnet driving units when the electromagnet driving units are powered on. A plurality of fan blades (not shown) can be formed on the rotator 120, when the rotator 120 is driven to rotate, the fan blades rotate together with the rotator 120 and drive the surrounding air to produce airflow and to cool the electronic components (not shown) of an electronic device 10.

An end of the shaft 1601 protrudes out of the rotator 120 and can be fixed to an external component 110 to provide support for the rotator 120 and increase the structure strength of the cooling fan 100. The protrusion part of the shaft 1601 can also prevent the rotator 120 from being compressed under load conditions.

In at least one exemplary embodiment, a coil assembly 140 is configured to be fixed around the shaft 1601, the coil assembly 140 is electrically connected to a driving circuit (not shown), the rotator 120 can include a bearing assembly (not shown) and at least one magnetic element 130 corresponding to the coil assembly 140, the rotator 120 is rotatably mounted to the shaft 1601 through the bearing assembly. The magnetic element 130 can be a permanent magnet made of permanent magnet materials.

When the coil assembly 140 is powered on, the rotator 120 is driven by the electromagnetic force of the coil assembly 140 through the magnetic element. For example, the bearing assembly can include a bearing sleeve and a bearing (both elements not shown) coupled in, the central portion of the rotator 120 can be thermally connected to the bearing sleeve. The bearing is sheathed on the shaft 1601. The rotator 120 and the bearing sleeve is driven to rotate around the shaft 1601 by the coil assembly 140.

In at least one exemplary embodiment, a receiving groove (not shown) can be defined on the shaft 1601, the coil assembly 140 can include a plurality of magnetic coils (not shown) received in the receiving groove. A circuit board (not shown) is configured to be electrically connected to the magnetic coils and is located adjacent to the receiving groove. The circuit board can include a supply circuit and a control circuit, the control circuit adjusts the speed of the rotator by adjusting the number of electrified magnetic coils. A peripheral portion of the rotator 120 extends along an axial direction of the rotator 120 and forms a flange 1201, the magnetic element 130 can be mounted to an inner surface of the flange 1201 and corresponds to the position of the magnetic coils.

A magnetic conductive element (not shown), such as a silicon steel sheet, can be inserted into the middle of the coil assembly 140. The magnetic conductive element can be provided with high magnetic flux density to focus the magnetic force into the magnetic coils.

The exemplary embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. a cooling fan, comprising:
a base;
a stator, the stator comprising two ends, one end mounted to the base and a shaft extending from the other end; and
a rotator mounted to the shaft;
wherein an end of the shaft protrudes out of the rotator, the rotator and the shaft each having an electromagnet driving unit, and the rotator is driven to rotate by the electromagnet driving unit.

2. The cooling fan of claim 1, wherein the rotator is rotatably mounted to the shaft, the rotator is driven by the electromagnet driving units to revolve around the shaft.

3. The cooling fan of claim 2, wherein a coil assembly is mounted around the shaft, the coil assembly is electrically connected to a driving circuit, the rotator comprises a bearing assembly and at least one magnetic element corresponding to the coil assembly, the rotator is rotatably mounted to the shaft through the bearing assembly; when the coil assembly is powered on, the rotator is driven by the electromagnetic force of the coil assembly through the magnetic element.

4. The cooling fan of claim 3, wherein the bearing assembly comprises a bearing sleeve and a bearing coupled in the bearing sleeve, the central portion of the rotator is fixed to the bearing sleeve, the bearing is sheathed on the shaft; the rotator and the bearing sleeve is driven by the coil assembly to rotate around the shaft.

5. The cooling fan of claim 4, wherein the bearing sleeve and the rotator are thermally attached to each other.

6. The cooling fan of claim 3, wherein the cooling fan further comprises a circuit board, the shaft comprises a receiving groove, the coil assembly comprises a plurality of magnetic coils received in the receiving groove, the circuit board is electrically connected to the magnetic coils and is located next to the receiving groove; the circuit board comprises a supply circuit and a control circuit, the control circuit adjusts the speed of the rotator by adjusting the number of electrified magnetic coils.

7. The cooling fan of claim 6, wherein a magnetic conductive element is inserted in a middle portion of the coil assembly.

8. The cooling fan of claim 6, wherein the magnetic conductive element is silicon steel sheet.

9. The cooling fan of claim 3, wherein a peripheral portion of the rotator extends along an axial direction of the rotator and forms a flange, the magnetic element is mounted to an inner surface of the flange and corresponds to the position of the magnetic coils.

10. The cooling fan of claim 3, wherein the magnetic element is made of permanent magnet materials.

11. An electronic device comprising:
at least one electronic component; and
a cooling fan for cooling the at least one electronic component comprising
a base;
a stator, the stator comprising two ends, one end mounted to the base and a shaft extending from the other end; and
a rotator mounted to the shaft;
wherein an end of the shaft protrudes out of the rotator, the rotator and the shaft each having an electromagnet driving unit, and the rotator is driven to rotate by the electromagnet driving unit.

12. The electronic device of claim 11, wherein the rotator is rotatably mounted to the shaft, the rotator is driven by the electromagnet driving units to revolve around the shaft.

13. The electronic device of claim 12, wherein a coil assembly is mounted around the shaft, the coil assembly is electrically connected to a driving circuit, the rotator comprises a bearing assembly and at least one magnetic element corresponding to the coil assembly, the rotator is rotatably mounted to the shaft through the bearing assembly; when the coil assembly is powered on, the rotator is driven by the electromagnetic force of the coil assembly through the magnetic element.

14. The electronic device of claim 13, wherein the bearing assembly comprises a bearing sleeve and a bearing coupled in the bearing sleeve, the central portion of the rotator is fixed to the bearing sleeve, the bearing is sheathed on the shaft; the rotator and the bearing sleeve is driven by the coil assembly to rotate around the shaft.

15. The electronic device of claim 14, wherein the bearing sleeve and the rotator are thermally attached to each other.

16. The electronic device of claim 13, wherein the electronic device further comprises a circuit board, the shaft comprises a receiving groove, the coil assembly comprises a plurality of magnetic coils received in the receiving groove, the circuit board is electrically connected to the magnetic coils and is located next to the receiving groove; the circuit board comprises a supply circuit and a control circuit, the control circuit adjusts the speed of the rotator by adjusting the number of electrified magnetic coils.

17. The electronic device of claim 16, wherein a magnetic conductive element is inserted in a middle portion of the coil assembly.

18. The electronic device of claim 16, wherein the magnetic conductive element is at least one silicon steel sheet.

19. The electronic device of claim 13, wherein a peripheral portion of the rotator extends along an axial direction of the rotator and forms a flange, the magnetic element is mounted to an inner surface of the flange and corresponds to the position of the magnetic coils.

20. The electronic device of claim 13, wherein the magnetic element is made of permanent magnet materials.
